(19) United States
(12) Patent Application Publication
(10) Pub. No.: US 2003/0131358 A1
(43) Pub. Date: Jul. 10, 2003

(54) SYSTEM AND PROCESS FOR ACCESSING DIGITAL DATA ON A VIDEO NETWORK

(76) Inventors: GERARD BUSCH, EVRY (FR); ROBERT KAPLAN, LE PERRAY EN YVELINES (FR)

Correspondence Address: YOUNG & THOMPSON, 745 SOUTH 23RD STREET 2ND FLOOR, ARLINGTON, VA, 22202

(21) Appl. No.: 09/110,201

(22) Filed: Jul. 6, 1998

(30) Foreign Application Priority Data
Nov. 18, 1997 (FR) 9714455

(51) Int. Cl. H04N 7/18; H04N 7/173; H04N 7/16; G06F 3/00; G06F 13/00

(52) U.S. Cl. 725/105; 725/135; 725/143

(57) ABSTRACT

This system (S) comprises, on a central site (CS), at least one central unit (CU) comprising a card (VC) for transmitting data over the video network (VN) and a card (GC) for converting digital format images into composite video images and, on a plurality of access sites (MR), television sets (TV) connected to a central unit (CU) via a video network (VN).

On each access site (MR), each television set (TV) is equipped with an infrared keyboard (CK) for selectively remotely controlling the central unit (CU) via the video network (VN) and, on the central site (CS), the central unit (CU) further comprises a card (CC) for connection to an external communications network and a card (IC) for receiving control signals transmitted by the respective infrared keyboards (CK) of each television set (TV) connected to the video network (VN).

Use in particular for accessing the Internet in multimedia rooms.

The present invention relates to a system for accessing digital data on a video network. It also relates to a process implemented in this system.

In private or public amenities or establishments (education, hospitals, hotels), there is currently a great demand for access to digital data originating from various sources such as Internet sites or storage disks (CD-ROMs, DVDs, etc.) containing videograms. Now, educational, administrative, industrial or cultural premises are often equipped with internal video networks using twisted pair cables, allowing broadcasting of information originating from multiple sources such as terrestrial or satellite television programmes, or pre-recorded cassettes. The Applicant has moreover developed a video switching system for these internal video networks allowing images and stereo sound to be distributed from a server to television sets via a single twisted pair, and in return allowing the sources to be controlled selectively, i.e. one device among others of the same brand and infrared protocol, from each television set, via an infrared remote control device.

There currently exist systems for accessing digital data which implement wideband transmission techniques and use for example fibre optic cable networks. With these access systems, it is possible to carry out an integral digital transmission from a digital data source to a receiver which may be digital or analog. However, such systems are currently particularly expensive and also require specific cabling. Until this “fully digital” distribution method becomes affordable, it will not be feasible to equip most collective premises and buildings involved in accessing digital data.

There also exist coaxial cable video distribution systems, but these systems, which have a limited bandwidth, do not allow high speed distribution of digital data and do not allow users of television sets or monitors connected to the video network to interact with the information sources, to access external networks and to remotely control certain browsing operations on communications networks such as the Internet.

The purpose of the present invention is to overcome these drawbacks by providing a system for accessing digital data on a video network which is less expensive than current systems and thus allows digital resources to be consulted in collective premises such as educational premises, hospitals or hotels, any tertiary or other buildings.

This objective is achieved using a system for accessing digital data on a video network, comprising:

on a central site, means for transmitting data over the video network, using twisted pair cables, and

on a plurality of access sites, television sets connected to the video network.

According to the invention, this system also comprises, at the level of the central site, means for converting digital data originating from local or remote digital resources into

analog data suitable for delivery via the video network.

The access system further comprises, at the level of the access sites, means for remotely controlling digital resources and, at the level of the central site, means for receiving control signals transmitted by the respective control means of each access site via the video network.

The access system according to the invention offers an original and economical solution to the problem of distributing and consulting digital data on sites equipped with existing video networks. Information and data originating from digital resources can thus be consulted using an existing audio-video network, which is economically very advantageous. Moreover, a major advantage of the system according to the invention resides, on the one hand, in the fact that the digital data thus converted can be delivered via a single twisted pair cable over a distance of up to 500 metres and, on the other hand, in the fact that the control signals are also transmitted over the same twisted pair cable, which is a new feature with respect to-existing systems.

In particular, the system according to the invention allows remote consultation and control of all the digital resources which can be accessed by an I.T. workstation located in a central site and connected to an internal or external network. This concerns in particular I.T. networks, Intranet or Internet.

Applications of the access system according to the invention can easily be envisaged in areas such as education (universities, colleges and secondary schools), hotels, hospitals, ships, air travel for passengers, conference centres

for simultaneous translation and the equipment of buildings or any intelligent sites.

A major advantage of the system according to the invention resides in particular in the fact that it provides access to the Internet network or to Intranet networks from television sets connected to a video network. Users of this system can receive images and sound originating from a computer connected to a digital network on a standard video screen and work on these images using a cordless keyboard without needing to move to the connection point. Moreover, the reception of Internet images on television sets offers appreciable quality of reception and display, in particular in classrooms.

Furthermore, the access system according to the invention allows users to learn how to use the Internet through collective viewing, and allows images originating from any point in the world to be used directly in the classroom. With the access system according to the invention, applications can also be envisaged which combine satellite reception with a large digital memory which can be operated directly on a classroom television set.

In companies, stores and public places, the viewing of images is made more ergonomic and more productive with the access system according to the invention, for example for commercial and tourist promotion applications intended for the general public.

In a preferred implementation of the invention, on each local access site, each television set is further fitted with local interface means placed between the television set and a video network connector of RJ45 or any other type,

these local interface means being designed, on the one hand, to receive control signals originating from the portable control device and, on the other hand, to transmit these control signals to the central unit via the video network.

It can advantageously be envisaged that the portable control device includes an infrared keyboard and that the local reception and transmission means includes means for converting the infrared signals received into signals which can be transmitted over the video network.

This implementation is particularly recommended for equipping multimedia rooms as it allows the presenter or teacher to control the central unit and to “surf” the Internet network without needing to be next to the television set.

The video networks concerned by the access system according to the invention are generally, but not exclusively, VDI networks (Voice/Data/Images). The access system according to the invention can preferably also include on the central site switching matrix means designed to connect the central unit and one or more other data sources to the video network, as well as means for managing the various requests for access to the central unit originating from the local access sites. It should be noted that each television set can also advantageously be provided with portable means for selecting the display on that set of a data source from the plurality of data sources which can be accessed from the switching matrix.

According to another aspect of the invention, a process is proposed for accessing digital data on a video network, implemented in the system according to the invention, characterized in that it includes the conversion of digital data originating from digital resources available from a central site into analog data suitable for delivery over a video network to be supplied to a plurality of access sites equipped with television sets connected to the video network.

This access process further includes, from each reception site equipped with a television set, the remote control of one or more digital resources. This remote control is for example implemented in the form of local input of control data and transmission of control signals over the video network. This process is particularly suitable for obtaining, from a television set connected to a video network, access to and browsing of the Internet network, but also to a local area network via an I.T. workstation connected to the network or via a server station. Using the process according to the invention, it is also possible to consult, distribute and remotely control the resources of a video-digital server via a single twisted pair cable.

Other features and advantages of the invention will further appear in the description below. In the attached figures provided as non-limitative examples:

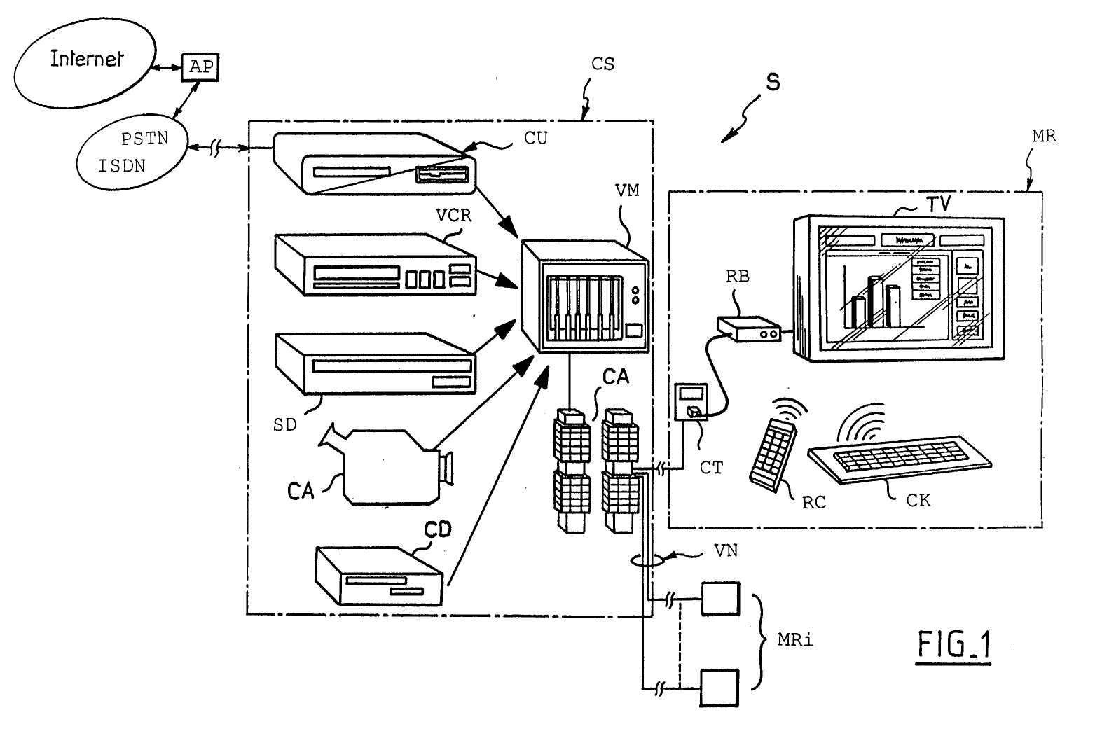

FIG. 1 shows an example of implementation of a system according to the invention;

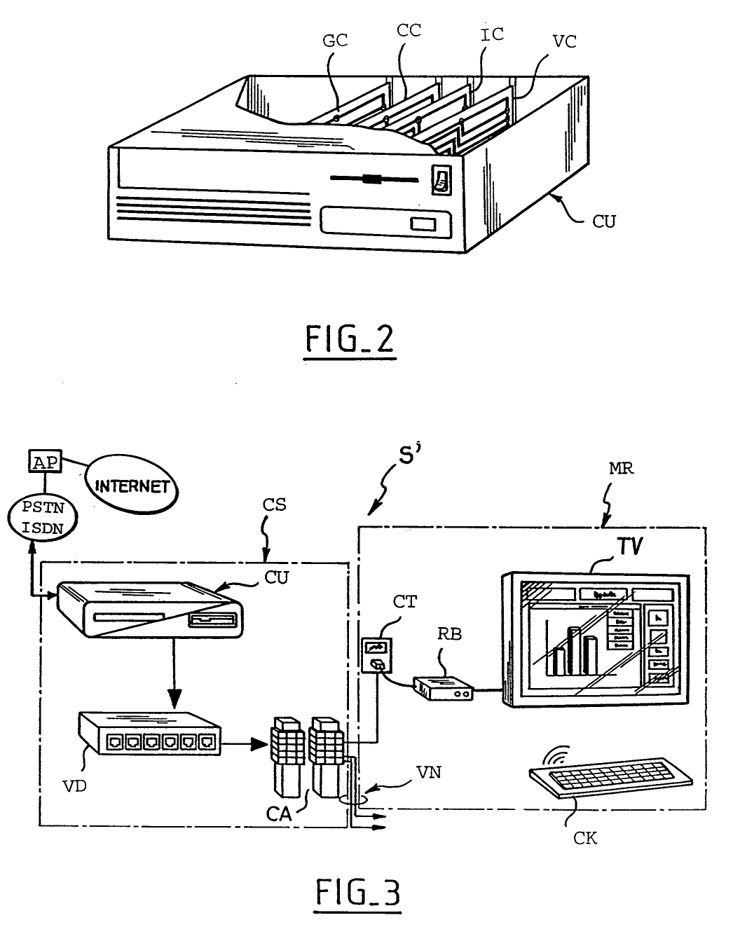

FIG. 2 shows an example of implementation of a central unit used as a video/I.T. interface; and

FIG. 3 shows an example of a simplified implementation of a system according to the invention.

There follows a description of an example of the implementation of an access system according to the invention, with reference to the aforementioned figures.

A system S for accessing digital data on a VDI network according to the invention comprises, with reference to FIG. 1, on a central site CS, a central unit CU providing the video/I.T. interface and connected, via the public switched telephone network PSTN or via any other communications network such as an integrated service digital network ISDN, by an access provider AP, to the Internet network, and an audio-video switching matrix VM connected to a two-wire structured network VN, for example a VDI (voice/data/image) network. The system S further comprises, in a set of local sites MRi, MR connected to the central site CS via the network VN, a television set TV connected to a connection terminal CT via a receiver box RB and equipped with a specific remote control device RC and an infrared keyboard CK allowing the remote control of the central unit CU. Such an infrared keyboard can for example be used at a distance of up to 7 metres from the television set, and preferably integrates a mouse and keys used to activate the required source.

The audio-video switching matrix VM is designed to receive data originating from several sources such as the central unit CU, a video cassette recorder VCR, a satellite demodulator SD, a video camera or a CD-ROM drive, and its output is connected to a cabling system CA to which the various branches of the video star network are connected.

The central unit CU is for example designed around a standard micro-computer equipped with a VGA interface card GC which converts VGA mode into high quality composite video, a card CC for accessing the Internet including a modem, an infrared reception card IC designed to receive the control signals transmitted from the infrared keyboard over the video network, and a card VC which transmits data over the video network. It should be noted that, in practice, the system according to the invention uses the video portion of a VDI network. The audio-video switching matrix allows all multimedia applications to be provided on a “twisted pair” type network.

The central unit CU can also be connected via a communications card such as an Ethernet® card to an I.T. network equipped with communications means allowing access to the Internet network via a telecommunications network such as the PSTN or an ISDN digital network.

In a simplified implementation of the invention, the access system S′ comprises, on the central site CS, the central unit CU providing the video/I.T. interface connected to a distribution box VD allowing the distribution of the information originating from the central unit to several multimedia rooms MR equipped with television sets TV and connected to a video network, with a receiver box RB placed between the television set TV and a terminal CT for connection to the video network, and with an infrared keyboard CK.

There follows a description of an example of implementation of the access process according to the invention, with reference to FIGS. 1 and 2. The example considered is a school equipped with a multimedia central site CS connected to the Internet network and to various other data sources such as satellite television programmes and a CD-ROM drive. During a geography lesson held in one of the school's multimedia rooms MR, a teacher decides to illustrate

his lesson by displaying documents which can be accessed on a financial journal's web site. To do this, he selects the corresponding data source from the remote control device RC, in this case the Internet network. The signals corresponding to this selection are transmitted via the VDI network to the switching matrix VM which, once the availability of the requested source has been tested, switches the video/I.T. interface central unit CU towards the multimedia room MR from which the access request originated. The teacher then picks up the infrared keyboard CK which has all the features of a computer keyboard including a trackball type device equivalent to a mouse. Using the cordless keyboard, the teacher establishes the connection to the site he wishes to consult, then browses this site or “surfs” to other sites, while the whole class observes these access and consultation operations in real time. This is made possible by the use of a television set which allows collective viewing under good conditions. The teacher will be able to provide a live commentary on the documents which he has accessed and optionally switch to another data source, for example a CD-ROM located on the central site CS using the specific remote control device RC.

It should be noted that the receiver box RB, which handles the reception of infrared signals originating from the control keyboard CK and optionally the remote control device RC and the transmission of these signals over the VDI network, can be produced using techniques which are well known in optoelectronics, video electronics and micro-computing. The same applies to the interface cards incorporated in the central unit CU.

The access system according to the invention can be used to access all the features available on Internet and Intranet networks, in particular creating pages, setting up links to Internet sites and discussion forums. It can of course retrieve numerous other data sources such as CD-ROMs or sources connected to an internal network.

In another advantageous application of the access system according to the invention in a school equipped with a satellite link with a supplier of films and documentaries, one or more films are downloaded via satellite on to a high capacity digital video disk which can be accessed on the central site. The film can then be viewed in full or in part on a television set in a room linked to the video network, when a teacher makes a selection, at a time of his choice. This application may also concern pay-TV services in hotels, aircraft, ships or hospitals.

Management of the access system according to the invention is carried out by the execution at the level of the central unit of a set of programs. There can in particular be mentioned addressable electronic mail programs, multi-site management programs and a program allowing multiplexing on demand of audio functions starting from a choice of more than two languages in the video signal. Specific service programs can be developed according to the area of activity of the access system according to the invention. Thus, for a hotel, these service programs may include video service invoicing and miscellaneous service reservation features. For a hospital, there can be envisaged the management of remote ordering of meals specific to a diet,

consulting a patient's notes at his bedside or viewing X-rays and NMR imagery on a television screen.

Of course, the invention is not limited to the examples which have just been described and numerous adjustments can be made to these examples without exceeding the scope of the invention. There can in particular be implemented other types of video network than the VDI network, or network structures other than star networks, for example bus architectures. Furthermore, the infrared control keyboard can be designed to include video (selection of source) and control features. It should be noted that the access system according to the invention can be adapted to any type of cabling and to any type of video and I.T. equipment on the market.

1. System (S, S′) for accessing digital data on a video network (VN), comprising:
on a central site (CS), means (VC) for transmitting data over the video network, and
on a plurality of access sites (MR, MRi), television sets (TV) connected to the video network (VN), characterized in that it further comprises, at the level of the central site (CS), means (GC) for converting digital data originating from local or remote digital resources into analog data suitable for transport over the video network (VN).

2. System (S, S′) according to claim 1, characterized in that it further comprises, at the level of the access sites (SM, SMi), means (CK) for selectively remotely controlling digital resources, and at the level of the central site (CS), means (IC) for receiving control signals transmitted via the video network (VN) by the respective control means (CK) of each access site (MR, MRi).

3. System (S, S′) according to claim 2, characterized in that the converted data and the control signals are transmitted over a single twisted pair cable.

4. System (S, S′) according to one of claims 2 or 3, characterized in that the central site (CS) is equipped with a central unit (CU) including conversion means (GC), means for accessing external internal digital resources and means for receiving control signals (IC).

5. System (S, S′) according to claim 4, characterized in that, on each access site (MR, MRi), each television set (TV) is further equipped with local interface means (RB) placed between the television set (TV) and a terminal (CT) for connection to the video network (VN), these local interface means (RB) being designed, on the one hand, to receive control signals originating from the control means (CK) and, on the other hand, to transmit these control signals to the central unit (CU) via the video network (VN).

6. System (S, S′) according to claim 5, characterized in that the control means (CK) comprise an infrared keyboard and in that the local reception and transmission means (RB) include means for converting the infrared signals received into signals which can be transmitted over the video network (VN).

7. System (S, S′) according to any one of claims 4 to 6, characterized in that it further comprises, at the level of the central site (CS), means (CC) for accessing an internal or external communications network.

8. System (S) according to any one of claims 4 to 6, characterized in that it further comprises on the central site (CS) switching matrix means (VM) provided for connecting to the video network (VN) the central unit (CU) and one or more other resources (VCR, SD, CA, CD), in particular digital resources.

9. System (S) according to claim 8, characterized in that it further comprises on the central site (CS) means for managing the various requests for access to the central unit (CU) originating from the local access sites.

10. System according to any one of the previous claims, characterized in that it further comprises, at the level of the central site, means for accessing an internal or external I.T. network.

11. System (S, S′) according to any one of the previous claims, characterized in that the video network is a VDI (voice/data/image) network.

12. Process for accessing digital data on a video network (VN), implemented in the system (S, S′) according to any one of the previous claims,
characterized in that it comprises a conversion of digital data originating from available digital resources from a central site (CS) into analog data suitable for transport over a video network (VN) to be supplied to a plurality of access sites (MR, MRi) equipped with television sets (TV) connected to the video network (VN).

13. Process according to claim 12, characterized in that it further comprises, from each reception site (MR) equipped with a television set (TV), the remote controlling of one or more digital resources.

14. Process according to claim 13, characterized in that the remote controlling of digital data comprises a local input of control data and the transmission of corresponding control signals over the video network (VN).

15. Process according to one of claims 12 to 14, characterized in that it is designed to provide access to and browsing of the Internet network from a television set (TV) connected to the video network (VN).
